(19) United States
(12) Patent Application Publication
(10) Pub. No.: US 2022/0397993 A1
(43) Pub. Date: Dec. 15, 2022

(54) SELECTING A DESIRED ITEM FROM A SET OF ITEMS

(71) Applicant: Swirl Design (Pty) Ltd., Western Cape (ZA)

(72) Inventor: Hendrik Frans Verwoerd Boshoff, Stellenbosch (ZA)

(21) Appl. No.: 17/837,955

(22) Filed: Jun. 10, 2022

(30) Foreign Application Priority Data
Jun. 11, 2021 (ZA) 2021/04023

(51) Int. Cl. G06F 3/0482; G06F 3/04812; G06F 3/0484

(52) U.S. Cl. CPC G06F 3/0482; G06F 3/04812; G06F 3/0484

(57) ABSTRACT

Methods, devices and computer program products are provided for display and interaction at a user interface. A guide is displayed that includes a number of guide frames arranged in a chain, each guide frame being associated with a subset of items from within a set of items and having a guide symbol displayed therein. In response to receiving user input associated with continuous movement of a pointer in the user interface, the guide is continuously changed so as to enlarge guide frames towards which the pointer is moving. Upon the pointer crossing a first threshold, the guide is replaced with a number of item frames which display items selected from the set of items. The item frames may be displayed in substantially the same position and of the same size as the guide frames which they replace.

### CROSS-REFERENCE TO RELATED APPLICATIONS

This application claims priority from South African provisional patent application number 2021/04023 filed on 11 Jun. 2021, which is incorporated by reference herein.

### FIELD OF THE INVENTION

This invention relates to display and interaction in a user interface. More particularly, the invention relates to a system and a method that enables a user to make a fast and easy selection of a desired item from a large set of items. The invention may be particularly, but not exclusively, suited to small displays (including rectangular or circular displays) and to larger displays of which only a portion of the display is to be used for displaying a set of display items for selection.

### BACKGROUND TO THE INVENTION

Users often need to navigate to and select an item from a large set of items. For example, a mobile device user may need to select a particular contact from a list of contacts and doing so may involve repeated actions such as scrolling, tapping or swiping to select a particular contact from a list of contacts. On a small display, such as on that of a smart watch, display space may be expected to be particularly limited and the above problems are exacerbated. Navigation may be particularly cumbersome on a smart watch with its associated small display.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

In the remainder of the specification, the term “pointer” should be construed to mean any user-controlled object or body part interacting with a user interface to control it. The pointer may, for example, be provided by a finger of a user or a stylus interacting with a touch-sensitive display associated with a user interface, or may be a pointer displayed on the user interface and controllable by an external input device such as a computer mouse. “Navigation” usually includes and mainly consists of moving the pointer. “Clutching” denotes a recalibration to avoid running out of input area, as when the edge of a user interface is reached, and a pointer must be lifted and moved to a new position.

### SUMMARY OF THE INVENTION

The present invention provides systems, methods and computer program products by which a user can make a fast and easy selection of a desired item from a large set of items in a user interface.

The method starts with a display of a guide to the items, the guide providing a context to a user in which to start an interactive navigation to the desired item. The guide may for example be a set of categories of the items, where each category is represented by a distinctive displayed symbol. The user provides an input indicating a starting point with respect to the guide, then steers the pointer in one continuous and uninterrupted movement, from the starting point to a position indicating the desired item. The guide may change continually in response to the navigation.

When the navigation crosses a predefined first threshold, the guide is replaced with a set of item frames, each containing a single item. The set of items displayed in the item frames may be changed in response to further navigation. If the navigation crosses a predefined second threshold, the item frames are replaced with the guide again. The method ends when the user concludes the continuous navigation, signaling either selection of the indicated item, or no selection at all.

The method therefore has two distinct phases or modes, a context mode in which the guide is displayed, and a focus mode in which the items are displayed. Changing or toggling between the context mode and focus mode is made in response to the user's navigation inputs.

The item frames are displayed during the focus mode, and their appearance and content changed in response to the users further navigation inputs. The user can make transitions between the context mode and the focus mode at will and in either direction, without clutching, which the applicant considers tedious and desirable to avoid. Navigation during the context mode covers many items in a short distance, while navigation during the focus mode glides from a single item to an adjacent item with enough space for easy selection. The control of focus and context navigation by a single uninterrupted user movement, enables fast and easy selection of any desired item from the set.

The crucial ‘memory’ in this method is an index to a currently indicated item, maintained during the focus mode. The index is set based on the position of crossing the first threshold (or the starting point, if beyond the first threshold) and it is updated during further focus navigation. Initially, and on any subsequent return to the context mode, the index is undefined.

In one illustrative embodiment, the user interface display is a touch screen, the display items represent the users contacts, and the guide symbols are mainly the (Roman) letters by which the contact names start. The symbols are displayed inside the circles of a chain having a sufficient number of members, and which is symmetric at the start. The changing inner circle of the chain forms the first predefined threshold. The user may touch down with a finger either inside or outside of this first threshold.

If the user touches down inside the first threshold, the guide chain is changed to reflect the eccentricity of the touch down point with respect to the original center of the chain. The direction of the eccentricity is interpreted as the users indication of which of the guide's letters are the most interesting; likely covering the desired contact. So the frames of the interesting symbols are enlarged at the expense of the opposite frames , while maintaining the property of contact between all chain frames. When the user slides the finger in any direction, the chain is continually adapted in a similar manner. If the finger is then lifted from inside the first threshold, it is taken as indicating no selection. Otherwise, if the finger is moved radially until it crosses the first threshold, the guide is replaced by another chain of about the same number of item frames (e.g., thirty). The thirty contacts displayed in these frames are selected based on the exact direction of crossing the first threshold. If, for example, the direction pointed roughly to the letter ‘R’, but precisely to 10% from its border with the letter ‘S’, the thirty contacts are selected to center upon the closest contact to 90% from the start of the contacts in category ‘R’. If the finger is then moved transversally around the chain, the asymmetry of the chain is changed to keep the largest circle under the finger, and the content of the frame at the far end from the finger is replaced by a new contact. In this way, the user can navigate the entire set of contacts, provided that enough revolutions around the chain are made with the finger. If the finger is lifted from the item frame chain, the nearest contact is selected, and the display changes to an action screen where various actions related to the contact can be selected by tapping the corresponding virtual button. However, if the finger is not lifted, but moved radially towards the inside of the chain, it may cross the second threshold, which is a circle well inside the first threshold to provide a degree of hysteresis. On such crossing, the guide chain is restored with suitable asymmetry to reflect the current finger position.

If the user touches down outside the first threshold, the chain of item frames is immediately displayed as it would appear had the user followed a path crossing the first threshold from the inside in the direction of the touch down point, and ending at the touch down point. Subsequent interaction is the same as described above for a touch down inside the first threshold.

The user can of course not be prevented from executing any touch trajectory that is possible within the physical constraints of the device. Some sensible provision therefore has to be made for all possible trajectories. For example, the user may repeatedly switch between the focus and context modes and circle around the chain multiple times. The user may also tap on a guide symbol. According to the description above, this would almost always lead to selection of an unintended item, due to the display space limitations of the guide. The implemented response to a tap in the embodiment is therefore to keep the guide display unchanged, and to inform the user of a better way to approach interaction with this method.

In another embodiment on a touch screen, the display items represent the keys on a keyboard, and the guide simply contains all of the keys standing for themselves. There may be 101 keys on a chain as the guide, and the item frames form another chain, but with only thirty members. On crossing the first threshold or touching down outside it, the focus mode appears with the thirty keys closest to the apparent key of interest, enabling quick adjustment after an imprecise start.

The user lifts to select the then indicated key, which enters its symbol into the text buffer. The reduction in the number of circles from, e.g., 101 in the context mode to 30 in the focus mode represents a real motor advantage during selection, in addition to the display advantage that is commonly found in keyboards with enlarged display on touch down.

The invention may be particularly, but not exclusively, suited to small displays (including rectangular and circular displays) and to larger displays where only a portion of the display is to be used for displaying a relatively large set of items for selection. In small displays, such as smartwatch displays, the space available to display information is typically limited, and when a user only wants to see limited information the present display and interaction method may enable relatively quick access to an item from a relatively large group of display items, such as 100, 500 or even 1,000 or more items.

The method may be implemented by means of a computer program product which comprises a computer-readable medium having stored computer-readable program code for performing the steps of the method. The computer-readable medium may be a non-transitory computer-readable medium and for the computer-readable program code executable by a processing circuit.

The disclosure accordingly provides a computer program product comprising a non-transitory computer readable storage medium having instructions encoded thereon that, when executed by a processor, cause the processor to perform, at a user interface, the steps of:

displaying a guide that includes a number of guide frames arranged in a chain, each guide frame being associated with a subset of items from within a set of items and having a guide symbol displayed therein;

in response to receiving a user input associated with continuous movement of a pointer in the user interface, continuously changing the guide so as to enlarge guide frames towards which the pointer is moving, the enlarging being in proportion to the movement;

upon the pointer crossing a first threshold, replacing the guide with a number of item frames, wherein the item frames display items selected from the set of items; and

enabling selection of an item displayed in the item frames.

The step of replacing the guide may include replacing the guide with the number of item frames displayed in substantially the same position and of the same size as the guide frames which they replace.

The guide frames may be arranged in a closed chain and the first threshold may be a closed loop.

The guide frames may each be elliptical and lie along a track formed between an inner elliptical border and outer elliptical border, with the guide frames all being tangent to the inner elliptical border and outer elliptical border. Each elliptical guide frame may touch its two neighbors in the chain.

Continuously changing the guide may continuously change the size of the inner elliptical border and continuously change a position of a center of the inner elliptical border, and the center of the inner elliptical border may be moved in an opposite direction to which the pointer moves. The guide frames may be continuously resized based on their position along the track, so that the guide frames all remain tangent to the inner elliptical border and outer elliptical border.

In one embodiment, one or more of the guide frames, inner elliptical border, outer elliptical border and item frames are hidden from view on the user interface while the guide symbols and items are displayed.

The first threshold may be coincident with the inner elliptical border. A second threshold may be provided which is within the first threshold. Crossing the second threshold may cause the item frames to be replaced by the guide frames so that the guide is displayed.

Items displayed in the item frames may be selected from within the set of items based on a direction of crossing the first threshold, or may be selected based on a proximity of the pointer to one or more guide frames when the pointer crosses the first threshold.

An item may be selected by navigating to the item and lifting the pointer from the user interface. Details of only that item may then enlarge and be displayed within the user interface.

Upon the guide being replaced by the set of item frames, the item frames may be arranged in a chain and movement of the pointer along the chain of item frames may cause the item frames to move and resize. The item frames may each be elliptical and lie along a track formed between an inner elliptical border and outer elliptical border, with the item frames all being tangent to the inner elliptical border and outer elliptical border. Movement of the pointer along the track may cause the item frames to move along the track in an opposite direction to which the pointer moves and to resize so that a largest item frame remains at the pointer.

In some embodiments, in response to an initial pointer touch down inside the first threshold, the guide chain is changed to reflect the eccentricity of the initial pointer touch down position with respect to a center of the chain. The guide chain may also be changed in response to an initial pointer touch down outside of the first threshold, by replacing the guide with the number of item frames.

The disclosure also provides a device having a user interface and comprising:

a processor;

a non-transitory computer readable storage medium having instructions encoded thereon that, when executed by the processor, cause the processor to:
display a guide that includes a number of guide frames arranged in a chain, each guide frame being associated with a subset of items from within a set of items and having a guide symbol displayed therein;
in response to receiving a user input associated with continuous movement of a pointer in the user interface, continuously change the guide so as to enlarge guide frames towards which the pointer is moving, the enlarging being in proportion to the movement;
upon the pointer crossing a first threshold, replace the guide with a number of item frames, wherein the item frames display items selected from the set of items; and
enable selection of an item displayed in the item frames.

The disclosure furthermore provides a display and interaction method in a user interface of a device including the steps of:

displaying a guide that includes a number of guide frames arranged in a chain, each guide frame being associated with a subset of items from within a set of items and having a guide symbol displayed therein;

in response to receiving a user input associated with continuous movement of a pointer in the user interface, continuously changing the guide so as to enlarge guide frames towards which the pointer is moving, the enlarging being in proportion to the movement;

upon the pointer crossing a first threshold, replacing the guide with a number of item frames, wherein the item frames display items selected from the set of items; and

enabling selection of an item displayed in the item frames.

Embodiments of the disclosure will now be described, by way of example only, with reference to the accompanying drawings.

### BRIEF DESCRIPTION OF THE DRAWINGS

In the drawings:

FIG. 1. shows a user device with a user interface having an initial context mode as displayed before interaction, showing alphabetic guides in a symmetric chain;

FIG. 2. shows the context mode after touch down near the middle, and during radial navigation in the direction of guide ‘Q’, showing the resulting guide chain asymmetry;

FIG. 3 shows a focus mode, after its activation by crossing a first threshold in the direction of guide ‘Q’, or after a direct touch down close to a center of guide ‘Q’, displaying the contacts selected for display based on the crossing or touch down direction;

FIG. 4 shows the details of a contact, with action buttons, after concluding the focus mode with selection of a specific contact by lifting a pointer from the touch screen;

FIG. 5 shows the focus state similar to FIG. 3., after a further navigation, transversally in the direction of contacts starting with ‘R’, showing the change in displayed contacts with respect to FIG. 3;

FIG. 6 shows the context mode again, after its reactivation by crossing a second threshold towards the center, and after further navigating in the direction of guide ‘D’;

FIG. 7 is a flow diagram illustrating steps performed during a display and interaction method; and

FIG. 8 illustrates an example of a computing device in which various aspects of the disclosure may be implemented.

### DETAILED DESCRIPTION WITH REFERENCE TO THE DRAWINGS

This disclosure provides methods, devices and computer program products which may allow a user to navigate to and select a desired item from a set of items, and to interact with the selected item to obtain a desired result. The disclosure enables a user to make a fast and easy selection of a desired item from a relatively large set of items.

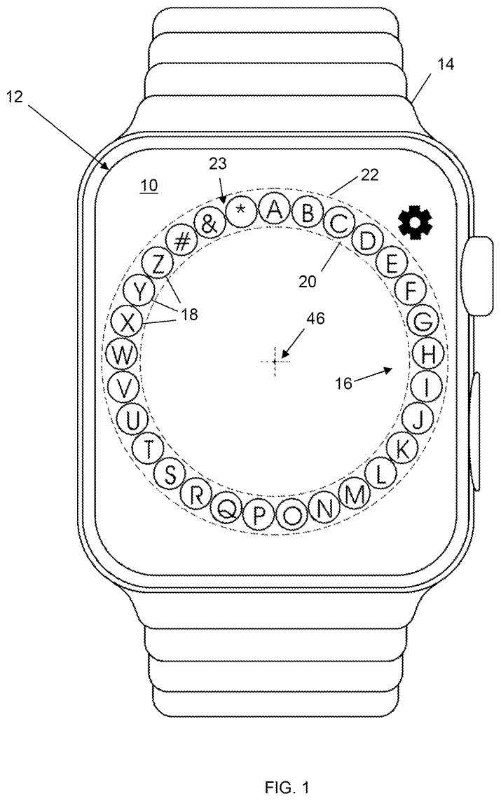

FIGS. 1 to 6 show a user interface (10). The user interface (10) may, for example, be provided by a display screen (12) of a user device (14) such as a smart watch or smart phone. The user device (14) may be provided with a touch-sensitive display screen (12) by which a user can interact with the user device (14), for example by using a pointer such as a finger. The touch-sensitive display (12) may in some embodiments be a rectangular or circular display.

The example of FIGS. 1 to 6 shows a contact picker or selector, where a user can rapidly locate one item (a contact) from within a large set of items (the user's phone book) associated with the user, and can then easily interact with the selected contact, such as to call or text the contact.

The method begins by displaying a guide (16) to the items, as shown in FIG. 1. The guide (16) provides a context to a user in which to start an interactive navigation to a desired item. The guide (16) may for example be a set of categories of the items, where each category is represented by a distinctive displayed symbol. In this example, the guide (16) is an alphabetic index, and the symbols are the twenty-six letters of the Roman alphabet (A-Z) as well as three special characters #, * and &. The guide symbols are the Roman letters by which the contact names start.

In this example, the guide symbol of each category is shown in a guide frame (18), where each guide frame (18) is associated with a subset of items from within a set of items—e.g., the guide frame with symbol “Q” is associated with a subset of items from the phone book, the subset being the contacts that start with the letter “Q”.

Each guide frame (18) may be an elliptical frame that may or may not be visible to the user. In this illustration, the elliptical frames are circular frames. The symbols are displayed inside these circular guide frames (18), with the circular guide frames (18) forming a closed chain. The illustrated chain consists of a finite number of ellipses (being the guide frames (18)) that are all tangent to two non-intersecting given ellipses—being an inner elliptical border (20) adjacent an inner edge of the chain and an outer elliptical border (22) adjacent an outer edge of the chain. The guide frames (18) therefore lie along a track (23) which is formed between the inner elliptical border (20) and outer elliptical border (22). In addition, in this embodiment with a closed chain, every circular guide frame (18) also touches its two neighbors in the chain while in other embodiments the guide frames (18) may be spaced apart or may partly overlap. The radius ratio of the outer and inner elliptical borders (22, 20) of a closed chain is constrained by the number of circles in the chain. The inner and outer elliptical borders (20, 22) are shown in broken lines as they are, in this embodiment, not shown on the display screen (12). In the illustrated embodiment, the inner and outer elliptical borders (20, 22) are circular.

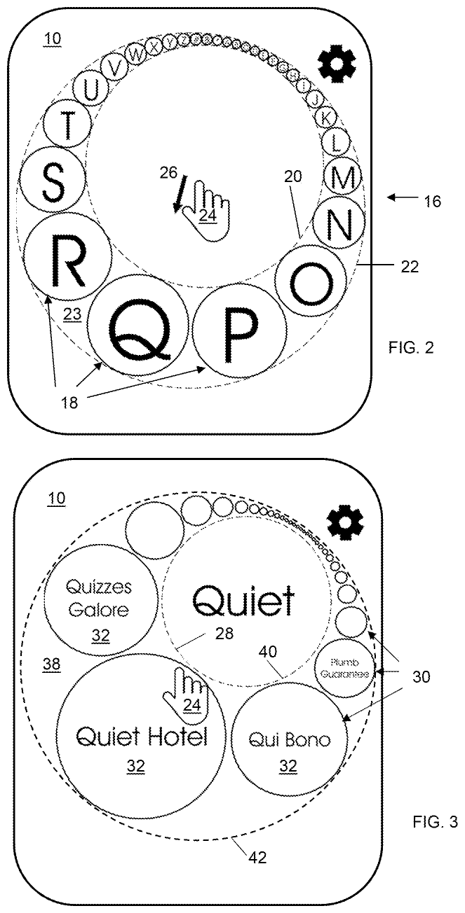

As shown in FIG. 2, a user provides an input using a pointer (24) indicating a starting point with respect to the guide (16). The user input may for example be a touch down and hold action, in which the pointer (24) is placed on the display screen (12). The pointer (24) is then moved, as indicated by a direction arrow (26), so as to steer an interactive navigation in one continuous and uninterrupted movement, from the original starting point to a position indicating a desired item. The guide (16) may continuously change in response to the navigation by continuously changing the size of the inner elliptical border (20) and continuously changing a position of a center of the inner elliptical border (20), while moving the center of the inner elliptical border in an opposite direction to which the pointer moves. By the user sliding the pointer (24) in the indicated direction (26), the guide (16) is updated so as to enlarge the guide frames (18) to which the user is moving as well as the symbols in those guide frames (18), the enlarging being in proportion to the movement. In this case, the user is moving radially in the direction of the symbol “Q” in the guide (16). The guide frames (18) of the interesting symbols are enlarged at the expense of the opposite frames, while maintaining the closed property of contact between all guide frames (18) in the chain. When the user slides the pointer (24) in any direction, the chain is continually adapted in a similar manner. The guide frames (18) are continuously resized based on their position along the track (23), so that the guide frames (18) all remain tangent to the inner elliptical border (20) and outer elliptical border (22).

Further movement in a radial direction causes the pointer (24) to cross a predefined first threshold (28), shown in FIG. 3. In this illustration the first predefined threshold (28) is a closed loop in the form of a circle extending inside the inner edge of the chain, and is therefore coincident with the inner elliptical border (20). The first predefined threshold (28) is of course not static but moves as the guide (16) changes.

When the navigation crosses the first threshold (28), the guide (16) is replaced with a set of item frames (30), each item frame (30) containing a single item (32) selected from the set of items. The item frames (30) may be rendered in substantially the same position and of the same size as the guide frames (18) which they replace. In this example, the items (32) are particular contact names stored in a list or phonebook of contacts. The items (32) displayed in the item frames (30) are selected from within the set of items based on the proximity of the pointer to one or more guide frames (18) when the pointer crosses the first threshold (28), or based on the direction of movement of the pointer (24) relative to one or more guide frames (18) when the pointer (24) crosses the first threshold (28). For example, if the pointer (24) were to cross the first threshold (28) exactly mid-way between “Q” and “R”, then the displayed contact names shown within the set of items (32) would be the end of the R-subset and the beginning of the Q-subset of contact names.

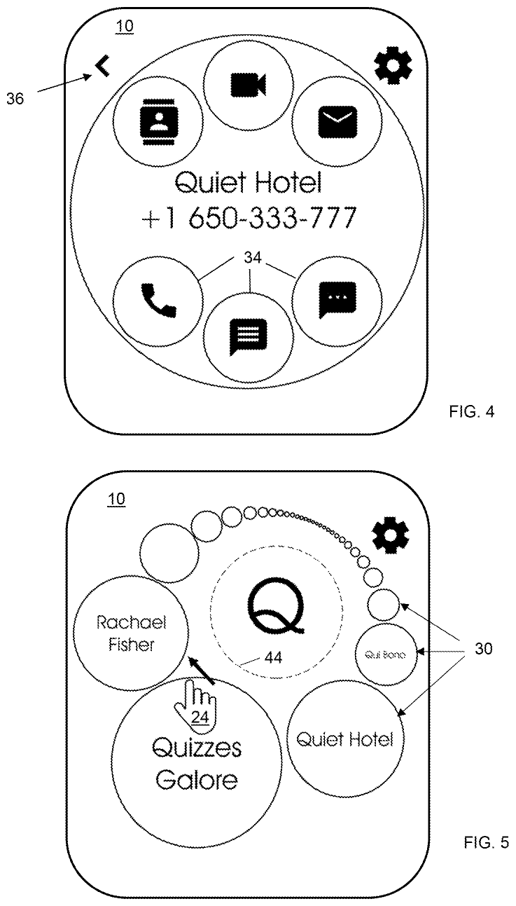

The method may end with the user concluding the continuous navigation, for example by lifting the pointer (24) from the display screen (12) while over a particular contact (e.g., Quiet Hotel). This signals selection of the indicated item and causes details of only that item to be displayed, as shown in FIG. 4, for example by enlarging only that item through animation. From the indication of the selected item, a number of shortcuts (34) may be displayed, such as shortcuts to call, text or instant message the contact, which then cause the desired action to be performed. A back indicator (36) may enable the user to transition back to the context guide (16) shown in FIG. 1.

The method therefore has two distinct phases or modes, namely a context mode in which the guide (16) is displayed as shown in FIGS. 1 and 2, and a focus mode in which the items (32) are displayed as shown in FIG. 3. Changing or toggling from the context mode to the focus mode is made in response to the user's navigation inputs by crossing the first threshold (28).

After having crossed the first threshold (28) as was shown in FIG. 3, the set of items (32) displayed in the item frames (30) may then be changed in response to further navigation. For example, if instead of lifting the pointer over “Quiet hotel” the user now moves the pointer in a transverse direction along the chain towards “Quizzes Galore”, as shown in FIG. 5, the appearance and content of the item frames (30) is changed in response to the user's further navigation inputs, with the movement of the pointer along the chain causing the item frames to move and resize. Here, “Quizzes Galore” has been enlarged and the chain of item frames (30) moves so that with a relatively small angular movement, “Quizzes Galore” now appears directly underneath the pointer (24).

In FIG. 3, the item frames (30) are each elliptical and are arranged in a chain lying along a track (38) formed between an inner elliptical border (40) and an outer elliptical border (42), with the item frames (30) all being tangent to the inner elliptical border (40) and outer elliptical border (42). Movement of the pointer (24) along the track (38) causes the item frames (30) to move along the track (38) in an opposite direction to which the pointer moves, and to resize so that a largest item frame (32) remains at the pointer.

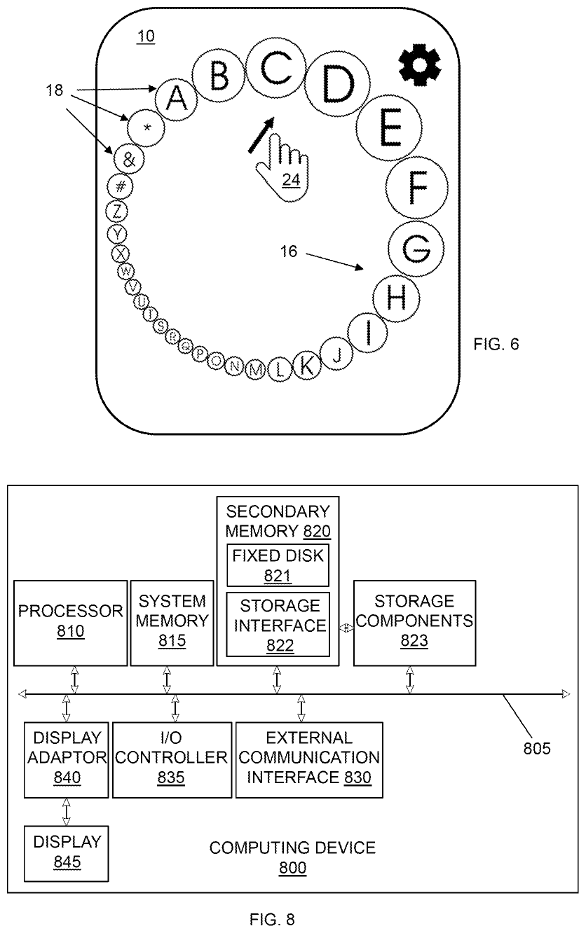

FIG. 5 also shows a defined second threshold (44). The second defined threshold (44) is well within the first defined threshold (28) to provide a degree of hysteresis. If the pointer (24) is moved radially to cross the second defined threshold (44), the item frames (30) are replaced with the guide (16) again. This is shown in FIG. 6 where the pointer (24) was moved from the position shown in FIG. 5 to cross the second defined threshold (44), causing the item frames (30) to be replaced with the guide (16). Further movement of the pointer (24) in the direction of guide symbol “D” has caused that item to enlarge.

The user can make transitions between the context mode in which only the guide (16) is displayed and the focus mode in which only the item frames (30) are displayed, at will and in either direction. Clutching is avoided since the symbols or items of interest are quickly moved into the correct position through a continuous navigation within the same display area. Navigation during the context mode covers many items in a short distance, while navigation during the focus mode glides from a single item to an adjacent item with enough space for easy control. The control of focus and context navigation by a single uninterrupted user movement, enables fast and easy selection of any desired item.

The user may initially touch down with a finger or pointer either inside or outside of the first threshold (28). If a user touches down inside the first threshold (28), the guide (16) chain is changed to reflect the eccentricity of the touch down point with respect to the original center (46—FIG. 1) of the chain. The direction of the eccentricity is interpreted as the users indication of which of the guide's letters are the most interesting; likely covering the desired contact. If the finger is then lifted from inside the first threshold, it is taken as indicating no selection. Otherwise, if the finger is moved radially until it crosses the first threshold, the guide is replaced by another chain of about the same number of circles forming the item frames (30). For example, with the original guide (16) chain having thirty items, thirty item frames can be displayed. The thirty items to display in the frames are selected based on the exact direction of crossing the first threshold. If, for example, the direction pointed roughly to the letter ‘R’, but precisely to 10% from its border with the letter ‘S’, the thirty contacts are selected to center upon the closest contact to 90% from the start of the contacts in category ‘R’. If the finger is then moved transversally around the chain, the asymmetry of the chain is changed to keep the largest item frame under the finger, and the content of the frame at the far end from the finger is replaced by a new contact. In this way, the user can navigate the entire set of contacts, provided that enough revolutions around the chain are made with the finger. If the finger is lifted from the item frame chain, the nearest contact is selected, and the display is changed to an action screen where various actions related to the contact can be selected by tapping the corresponding virtual button (as shown in FIG. 4).

However, if the finger is moved radially towards the inside of the chain, it may cross the second threshold (44), which is a circle well inside the first threshold to provide a degree of hysteresis. On such crossing, the guide (16) chain is restored with suitable asymmetry to reflect the current finger position (as shown in FIG. 6).

The crucial ‘memory’ in this method is an index to the currently indicated item, maintained during the focus mode. The index is set based on the position of crossing the first threshold (or the starting point, if beyond the first threshold) and it is updated during further focus navigation. Initially, and on any subsequent return to the context mode, the index is undefined.

A further feature is that if the user touches down outside the first threshold (28), the chain of item frames is immediately displayed as it would appear had the user followed a path crossing the first threshold from the inside in the direction of the touch down point, and ending at the touch down point. Subsequent interaction is the same as described above for a touch down inside the first threshold.

The user can of course not be prevented from executing any touch trajectory that is possible within the physical constraints of the device. Some sensible provision therefore has to be made for all possible trajectories. For example, the user may repeatedly switch between the focus and context modes and circle around the chain multiple times. The user may also tap on a guide.

According to the description above, this would almost always lead to selection of an unintended item, due to the display space limitations of the guide. The implemented response to a tap is therefore to keep the guide display unchanged, and to inform the user of a better way to approach interaction with this method such as by a hovering message such as “Please stroke from the center!” or the like.

In the illustrated example embodiment, while the guide symbols and items (32) are displayed in the user interface (10), the guide frames (18), inner elliptical border (20), outer elliptical border (22) and item frames (30) are all hidden from view. It will, of course, be apparent that any of these could be partially or fully displayed depending on the specific user interface implementation required.

To support users of different languages in a contact picker, the symbols in this embodiment may be replaced with those of the respective scripts used to write contact names, which may be alphabets (e.g. Greek, Cyrillic, Hangul), or non-alphabetic writing systems (like Devanagari or Hanzi).

In another embodiment on a touch screen, the display items may represent the keys on a keyboard, and the guide simply contains all of the keys standing for themselves. There may be 101 keys on a chain as the guide, and the item frames form another chain, but with a smaller number of members, e.g., thirty members. On crossing the first threshold or touching down outside it, the focus mode appears with the thirty keys closest to the apparent key of interest, enabling quick adjustment after an imprecise start. The user lifts to select the then indicated key, which enters its symbol into the buffer. The reduction in the number of circles from 101 in the context mode to thirty in the focus mode represents a real motor advantage during selection, in addition to the display advantage that is commonly found in keyboards with enlarged display on touch down.

In another embodiment on a touch screen, the items may be photos or videos, while the guide is based on the photo/video dates or locations.

The method may be implemented on display screens that are round or any other shape. For example, a specific display area may be provided on a display device, for example a rectangular screen, and the present display and interaction method may be equally well used on such a display. Examples of devices with rectangular screens include mobile phones, tablets, phablets, televisions, or the like. An elliptical or circular area may be demarcated on such rectangular screen, where the present display and interaction method may be implemented.

It should be noted that the present invention may be usable with any type of user interface provided by any suitable electronic device. It need not only be used with a smartwatch as per the above examples. The user interface may be provided by a smartphone, a tablet, a laptop computer, a desktop computer, or the like. Instead of circles, ellipses could also be used.

The disclosed method and system may enable relatively quick access to an item from a relatively large group of display items, such as 100, 500, or even 1,000 or more items.

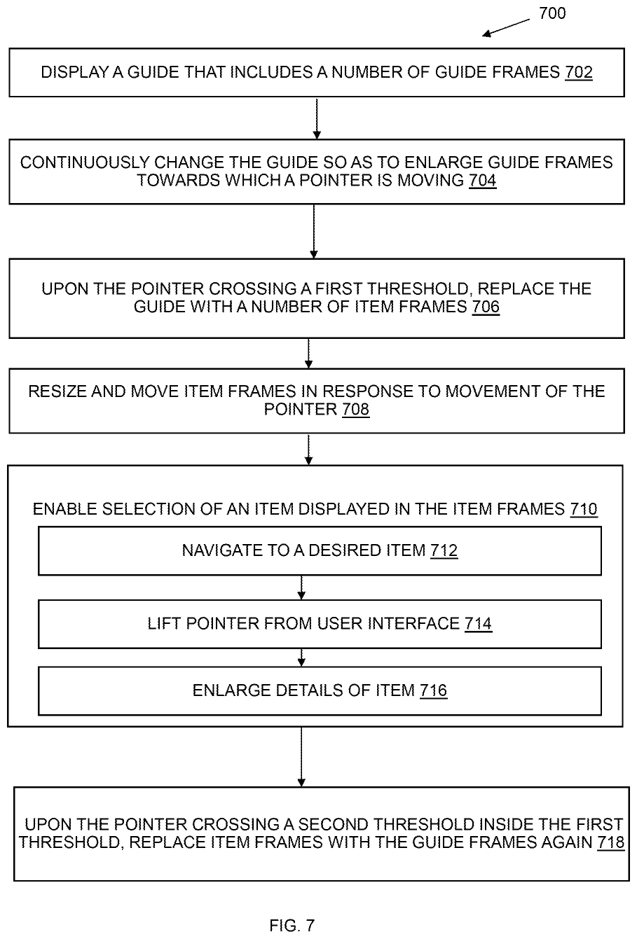

FIG. 7 shows a method (700) of display and interaction in a user interface of a device, such as in the user interface (10) of the device (14) of FIG. 1. The steps of the method (700) are carried out by computer program code stored in a non-transitory computer readable storage medium, and thus shows the steps of a computer program product comprising a non-transitory computer readable storage medium having instructions encoded thereon. According to an embodiment of the method, a guide is displayed (702). The guide may include a number of guide frames arranged in a chain, with each guide frame being associated with a subset of items from within a set of items and having a guide symbol displayed therein. In response to receiving user input associated with continuous movement of a pointer in the user interface, the guide is continually changed (704) so as to enlarge guide frames towards which the pointer is moving, the enlarging being in proportion to the movement. Upon the pointer crossing a first threshold, the guide is replaced (706) with a number of item frames, which may be displayed in substantially the same position and of the same size as the guide frames which they replace, wherein the item frames display items selected from the set of items. Movement of the pointer along the chain of item frames may then cause the item frames to resize (708) and move, so that a desired item can be reached.

Selection of an item displayed in the item frames is then enabled (710). Selection an item may be by means of using the pointer to navigate (712) to the item and then lifting (714) the pointer from the user interface. This may cause details of only that item to enlarge (716) and be displayed within the user interface.

Further steps of the method (700) may provide that upon the pointer crossing a second threshold which is provided within (i.e., inside) the first threshold, the item frames are replaced (718) with the guide frames again so that the guide is displayed. The guide frames are displayed in substantially the same position and of the same size as the item frames which they replace.

FIG. 8 illustrates an example of a computing device (800) at a user interface (such as user interface 10) in which various aspects of the disclosure may be implemented. The computing device (800) may be embodied as any form of data processing device including a personal computing device (e.g. laptop or desktop computer), a server computer (which may be self-contained, physically distributed over a number of locations), a client computer, or a personal device, such as a mobile phone (e.g. cellular telephone), smart watch, satellite phone, tablet computer, personal digital assistant, wearable device or the like. Different embodiments of the computing device may dictate the inclusion or exclusion of various components or subsystems described below. The user interface may be any form of human-machine interface such as a display screen, touch sensitive display, heads-up display, virtual reality device, augmented reality device or the like. User input may be provided by means of a user-controlled object or body part interacting with the user device, such as a finger of a user or a stylus interacting with a touch-sensitive display associated with a user interface, a pointer displayed on the user interface and controllable by an external input device such as a computer mouse, head movement of a user controlling a virtual reality headset or augmented reality glasses, or user body part controlling a wearable user interface.

The computing device (800) may be suitable for storing and executing computer program code. The various participants and elements previously described may use any suitable number of subsystems or components of the computing device (800) to facilitate the functions described herein. The computing device (800) may include subsystems or components interconnected via a communication infrastructure (805) (for example, a communications bus, a network, etc.). The computing device (800) may include one or more processors (810) and at least one memory component in the form of computer-readable media. The one or more processors (810) may include one or more of: CPUs, graphical processing units (CPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (800) may be distributed over a number of physical locations (e.g., in a distributed, cluster or cloud-based computing configuration) and appropriate software units may be arranged to manage and/or process data on behalf of remote devices.

The memory components may include system memory (815), which may include read only memory (ROM) and random access memory (RAM). A basic input/output system (BIOS) may be stored in ROM. System software may be stored in the system memory (815) including operating system software. The memory components may also include secondary memory (820). The secondary memory (820) may include a fixed disk (821), such as a hard disk drive, and, optionally, one or more storage interfaces (822) for interfacing with storage components (823), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (800) may include an external communications interface (830) for operation of the computing device (800) in a networked environment enabling transfer of data between multiple computing devices (800) and/or the Internet. Data transferred via the external communications interface (830) may be in the form of signals, which may be electronic, electromagnetic, optical, radio, or other types of signal. The external communications interface (830) may enable communication of data between the computing device (800) and other computing devices including servers and external storage facilities. Web services may be accessible by and/or from the computing device (800) via the communications interface (830).

The external communications interface (830) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry.

The computer-readable media in the form of the various memory components may provide storage of computer-executable instructions, data structures, program modules, software units and other data. A computer program product may be provided by a computer-readable medium having stored computer-readable program code executable by the central processor (810). A computer program product may be provided by a non-transient or non-transitory computer-readable medium, or may be provided via a signal or other transient or transitory means via the communications interface (830).

Interconnection via the communication infrastructure (805) allows the one or more processors (810) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (800) either directly or via an I/O controller (835). One or more user interfaces (845) (which may be touch-sensitive displays) may be coupled to or integrally formed with the computing device (800) via a display or video adapter (840).

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. Components or devices configured or arranged to perform described functions or operations may be so arranged or configured through computer-implemented instructions which implement or carry out the described functions, algorithms, or methods. The computer-implemented instructions may be provided by hardware or software units. In one embodiment, a software unit is implemented with a computer program product comprising a non-transient or non-transitory computer-readable medium containing computer program code or instructions, which can be executed by a processor for performing any or all of the steps, operations, or processes described. Software units or functions described in this application may be implemented as computer program code using any suitable computer language such as, for example, Java™ C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the invention in terms of algorithms and symbolic representations of operations on information. These algorithmic descriptions and representations, such as accompanying flow diagrams, are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention set forth in any accompanying claims.

1. A computer program product comprising a non-transitory computer readable storage medium having instructions encoded thereon that, when executed by a processor, cause the processor to perform, at a user interface, the steps of:
displaying a guide that includes a number of guide frames arranged in a chain, each guide frame being associated with a subset of items from within a set of items and having a guide symbol displayed therein;
in response to receiving a user input associated with continuous movement of a pointer in the user interface, continuously changing the guide so as to enlarge guide frames towards which the pointer is moving, the enlarging being in proportion to the movement;
upon the pointer crossing a first threshold, replacing the guide with a number of item frames, wherein the item frames display items selected from the set of items; and
enabling selection of an item displayed in the item frames.

2. The computer program product as claimed in claim 1 wherein the step of replacing the guide includes replacing the guide with the number of item frames displayed in substantially the same position and of the same size as the guide frames which they replace.

3. The computer program product as claimed in claim 1 wherein the guide frames are arranged in a closed chain and the first threshold is a closed loop.

4. The computer program product as claimed in claim 1 wherein the guide frames are each elliptical and lie along a track formed between an inner elliptical border and outer elliptical border, with the guide frames all being tangent to the inner elliptical border and outer elliptical border.

5. The computer program product as claimed in claim 4 wherein each elliptical guide frame touches its two neighbors in the chain.

6. The computer program product as claimed in claim 4 wherein continuously changing the guide continuously changes the size of the inner elliptical border and continuously changes a position of a center of the inner elliptical border.

7. The computer program product as claimed in claim 4 wherein a center of the inner elliptical border is moved in an opposite direction to which the pointer moves.

8. The computer program product as claimed in claim 4 wherein the guide frames are continuously resized based on their position along the track, so that the guide frames all remain tangent to the inner elliptical border and outer elliptical border.

9. The computer program product as claimed in claim 4 wherein the guide frames, inner elliptical border, outer elliptical border and item frames are hidden from view on the user interface while the guide symbols and items are displayed.

10. The computer program product as claimed in claim 4 wherein the first threshold is coincident with the inner elliptical border.

11. The computer program product as claimed in claim 3 wherein a second threshold is provided which is within the first threshold, and wherein crossing the second threshold causes the item frames to be replaced by the guide frames so that the guide is displayed.

12. The computer program product as claimed in claim 1 wherein the items displayed in the item frames are selected from within the set of items based on a direction of crossing the first threshold.

13. The computer program product as claimed in claim 1 wherein the items displayed in the item frames are selected from within the set of items based on a proximity of the pointer to one or more guide frames when the pointer crosses the first threshold.

14. The computer program product as claimed in claim 1 wherein an item is selected by navigating to the item and lifting the pointer from the user interface.

15. The computer program product as claimed in claim 1 wherein selection of an item causes details of only that item to enlarge and be displayed within the user interface.

16. The computer program product as claimed in claim 1 wherein, upon the guide being replaced by the set of item frames, the item frames are provided in a chain and movement of the pointer along the chain of item frames causes the item frames to move and resize.

17. The computer program product as claimed in claim 1, wherein the item frames are each elliptical and lie along a track formed between an inner elliptical border and outer elliptical border, with the item frames all being tangent to the inner elliptical border and outer elliptical border, and wherein movement of the pointer along the track causes the item frames to move along the track in an opposite direction to which the pointer moves and to resize so that a largest item frame remains at the pointer.

18. The computer program product as claimed in claim 3 including the steps of,
in response to an initial pointer touch down inside the first threshold, changing the guide chain to reflect the eccentricity of the initial pointer touch down position with respect to a center of the chain; and
in response to an initial pointer touch down outside the first threshold, replacing the guide with the number of item frames.

19. A device having a user interface and comprising:
a processor;
a non-transitory computer readable storage medium having instructions encoded thereon that, when executed by the processor, cause the processor to:
display a guide that includes a number of guide frames arranged in a chain, each guide frame being associated with a subset of items from within a set of items and having a guide symbol displayed therein;
in response to receiving a user input associated with continuous movement of a pointer in the user interface, continuously change the guide so as to enlarge guide frames towards which the pointer is moving, the enlarging being in proportion to the movement;
upon the pointer crossing a first threshold, replace the guide with a number of item frames, wherein the item frames display items selected from the set of items; and
enable selection of an item displayed in the item frames.

20. A display and interaction method in a user interface of a device including the steps of:
displaying a guide that includes a number of guide frames arranged in a chain, each guide frame being associated with a subset of items from within a set of items and having a guide symbol displayed therein;
in response to receiving a user input associated with continuous movement of a pointer in the user interface, continuously changing the guide so as to enlarge guide frames towards which the pointer is moving, the enlarging being in proportion to the movement;
upon the pointer crossing a first threshold, replacing the guide with a number of item frames, wherein the item frames display items selected from the set of items; and
enabling selection of an item displayed in the item frames.
